(19) United States
(12) Patent Application Publication
(10) Pub. No.: US 2008/0303902 A1
(43) Pub. Date: Dec. 11, 2008

(54) SYSTEM AND METHOD FOR INTEGRATING VIDEO ANALYTICS AND DATA ANALYTICS/MINING

(75) Inventors: Kevin Douglas ROMER, Delray Beach, FL (US); Shuhai SHEN, Winchester, MA (US); Amber Marsel HEROLD, Del Mar, CA (US)

Correspondence Address: Christopher & Weisberg, P.A., 200 East Las Olas Boulevard, Suite 2040, Fort Lauderdale, FL, 33301, US

(73) Assignee: Sensomatic Electronics Corporation, Boca Raton, FL (US)

(21) Appl. No.: 12/135,722

(22) Filed: Jun. 9, 2008

Related U.S. Application Data
(60) Provisional application No. 60/933,778, filed on Jun. 9, 2007.

(51) Int. Cl. H04N 7/18

(52) U.S. Cl. 348/143; 348/E07.085

(57) ABSTRACT

A method and system detects potential suspicious behavior in a monitored facility. The monitored facility includes at least one point of transaction terminal. Video content of an activity occurring at the monitored facility and transaction data relating to a transaction processed at the transaction terminal are collected. The video content is correlated with the transaction data to produce correlated data. A set of user-defined rules are applied to the correlated data. Responsive to identifying a match between the correlated data and at least one rule of the set of user-defined rules, the transaction is determined to be potentially suspicious.

### CROSS-REFERENCE TO RELATED APPLICATION

This application is related to and claims priority to U.S. Provisional No. 60/933,778, filed Jun. 9, 2007, entitled “System and Methods for Integrating Video Analytics and Data Analytics/Mining,” the entirety of which is incorporated herein by reference.

### STATEMENT REGARDING FEDERALLY SPONSORED RESEARCH OR DEVELOPMENT

n/a

### FIELD OF THE INVENTION

The present invention relates generally to a system and method for analyzing video and more particularly to a system and method for integrating video analytics and data analytics/data mining that exploit the strengths of both video and data analytics.

### BACKGROUND OF THE INVENTION

The use of video surveillance and analysis has become commonplace in deterring shoplifting and theft in retail stores. However, in retail and other settings there is often too much data and video being collected from security and business operations for humans to manage effectively and efficiently. With tighter budgets and pressures on limiting headcount, the burdens are even greater. Businesses need tools to filter and mine the data so they can determine exceptions, patterns and/or anomalistic behavior. In addition, there are more sophisticated threats of collusion, ranging from cashier “sweethearting” transactions (bypassing scanners) for their own or a customer's benefit, to organized crime groups which work together across multiple incidences and multiple sites.

Some have tried to address and manage these problems from a business operations standpoint with solutions that are based on analyzing the data available from store systems, such as the point of sale, to identify patterns of abnormal behavior that indicate areas of concern. Improvements to these solutions include having these patterns trigger video clips from the video surveillance system that provide visual verification of the situation. Others have approached the problem from a security standpoint, using computer algorithms to analyze the video from video surveillance systems, so that that some level of abnormal behavior can be detected visually in the scene independent of other triggers and used to implement strategies in business operations.

This business-data-alone approach fails for several reasons. The data characterizing the situation may not be available because the store system may have been bypassed. Also, the data system tends to be post event mining, which limits its ability to handle real time/time sensitive alerts and notification. Given the data systems' limitations described above and the dependency of the video clip playback on the data trigger, this enhancement has failed also. The stand alone analysis of the video is problematic because it can be prone to false alarms or inadequate accuracy levels to make it reliable. Also these arrangements tend to require event configuration/definition of rules to detect the anomalies and these patterns may not be understood ahead of time.

Accordingly, what is needed is a system and method for integrating video analytics and data analytics/data mining that exploits the strengths of both video and data analytics to compensate for the limitations with previous solutions. What is also needed is integration software that is able to provide business and operational intelligence to the operation of facility entry/exit points, sales and service points, and throughout the interior and exterior.

### SUMMARY OF THE INVENTION

The present invention advantageously provides a method and system to integrate video analytics techniques with data analytics techniques to more accurately identify potentially suspicious behavior and events requiring attention of management personnel. Generally speaking, the present invention provides a method and system for monitoring facilities, such as retail stores or warehouses, using data collected at point of sale registers to more accurately recognized objects and events detected simultaneously through a video monitoring system.

One aspect of the present invention includes a method for detecting potential suspicious behavior in a monitored facility. Video content of an activity occurring at the monitored facility and transaction data relating to a transaction processed at a point of transaction terminal are collected. The video content is correlated with the transaction data to produce correlated data. A set of user-defined rules are applied to the correlated data. Responsive to identifying a match between the correlated data and at least one rule of the set of user-defined rules, the transaction is determined to be potentially suspicious.

Another aspect of the present invention includes a method of automatically identifying activities occurring at a monitored facility. Video content of activity occurring at the monitored facility is collected. The video content is analyzed using object recognition techniques by applying a set of video analytics rules to the collected video information. Transaction data relating to one or more transactions processed by at least one point of transaction terminal within the sales facility is also collected. In response to determining that the video content conforms to at least one video analytics rule of the set of video analytics rules, the video content is correlated with the transaction data to provide correlated transaction data.

In accordance with another aspect of the present invention, a system for analyzing activities occurring at a monitored facility includes a video analytics system, a data analytics system, and an integration server. The integration server is communicatively coupled to the video analytics system and the data analytics system. The monitored facility includes at least one point of sale register. The video analytics system collects video content of activities occurring at the monitored facility. The data analytics system collects transaction data relating to one or more transactions processed by the at least one point of transaction terminal. The integration server correlates the video content to the transaction data to produce correlated data. The integration server also applies a set of user-defined rules to the correlated data and identifies a match between the correlated data and at least one rule of the set of user-defined rules.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary video and data analytic system constructed in accordance with the principles of the present invention;

FIG. 2 is a block diagram of exemplary video and data monitoring points constructed in accordance with the principles of the present invention;

FIG. 3 is a flowchart of an exemplary return transaction process performed according to the principles of the present invention;

FIG. 4 is a flowchart of an exemplary cash void transaction process performed according to the principles of the present invention;

FIG. 5 is a flowchart of an exemplary customer counting process performed according to the principles of the present invention;

FIG. 6 is a flowchart of an exemplary process to automatically link transactional exceptions to indexed video performed according to the principles of the present invention;

FIG. 7 is a flowchart of an exemplary line duration measuring process performed according to the principles of the present invention;

FIG. 8 is a flowchart of an exemplary cash drawer opening as detected by video analytics without transactions detection process performed according to the principles of the present invention;

FIG. 9 is a flowchart of an exemplary process to set up point of sale (“POS”) rules and generate exceptions performed according to the principles of the present invention;

FIG. 10 is a flowchart of an exemplary process to set up user-definable video rules and generate alerts performed according to the principles of the present invention;

FIG. 11 is a flowchart of an exemplary process to set up user-definable store data and video rules combinations performed according to the principles of the present invention; and

FIG. 12 is a flowchart of an exemplary reporting process performed according to the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for analyzing video to determine the presence of an alarm condition by integrating video analytics with data analytics/data mining techniques. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a method and system for analyzing video using a combination of video analytics and data analytics/data mining techniques. In one embodiment, the invention may include software consisting of user interfaces, e.g., Client/Browser, management and analysis components, and reporting capabilities. A video system with embedded analytics at the edge, video storage at a digital video recorder (“DVR”) or other storage device, and retail transaction data devices may also be included.

In another embodiment, a user interface allows users to define the configurations and rules, pre-event, as well as conducting the mining of the data and video, after the fact. The video and data systems may be networked together and communicate via database transmissions and queries as well as Application Programming Interfaces. The video and data analysis nodes may have the ability to process their analysis in an embedded, distributed manner, and transfer processed meta-data to the system databases.

An extremely versatile embodiment of the present invention enables the addition of new pre-packaged and customer defined rules and measurements of operational metrics called Key Performance Indicators (“KPIs”). By understanding the problems and opportunities with customers, the system may be used to define use cases that are the basis for generating the enabling rules and KPIs.

The system may be programmable to trigger alerts in real time, as well as mine patterns of data and behavior after the fact, and combine both sources of information so to enhance the ability to address more complex and a wide range of use cases. The system may also be programmable to combine the triggers from video analysis and data analysis in the following comprehensive combinations: Data Analytics Trigger-Video verification, Video Analytics Trigger-Data Verification, Data Analytics Trigger-Video Analytics Verification, Video Analytics Trigger-Data Analytics Verification.

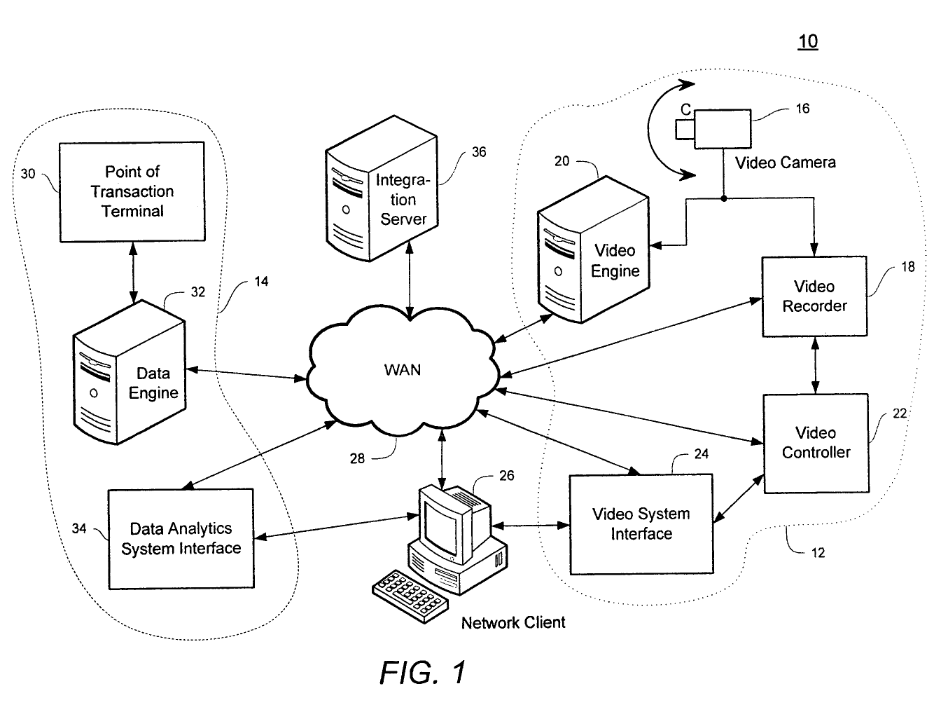

Referring now to the drawing figures in which like reference designators refer to like elements, there is shown in FIG. 1 an exemplary business intelligence system 10 for integrating video analytics and data analytics/data mining that exploits the strengths of both video and data analytics constructed in accordance with the principles of the present invention. The business intelligence system 10 may be structured to support enterprise-wide video solutions and broader use cases across retail operations.

The business intelligence system 10 combines a video analytics subsystem 12 with a data analytics subsystem 14 to model and detect suspicious activities and store/warehouse management events. The video analytics subsystem 12 may include one or more video cameras 16 (one shown), a video recorder 18, a video engine 20, a video controller 22, and a video system interface 24. The video camera 16 captures images of activity within a local viewing area and transfers the images to the video recorder 18 and/or the video engine 20. The video recorder 18 may time-stamp and store the captured images for later recall. The video engine 20 performs object recognition/detection functions on the captured images to determine whether images captured by the video camera 16 meet conditions determined according to preset rules. Note that the function of the video engine 20 may be embedded in the video camera 16 or other edge devices to allow processing of live video in addition to video stored in the video recorder 18. Additionally, time-stamping may also be performed by the video camera 16 or some other intermediate device. The video controller 22 controls the basic configuration of the video system, such as which video cameras 16 are active, the pan, tilt, angle, and zoom settings for each video camera 16, playback of requested video segments, etc. The video system interface 24 allows a user to set the rules and conditions for the video analytics server 20 and to choose specific video segments for playback.

Each component of the video analytics subsystem 12 may be directly coupled to other components in the video analytics subsystem 12 at a local level. Alternatively and/or additionally, each component of the video analytics subsystem 12 may be linked to other components in the video analytics subsystem 12, the data analytics subsystem 14, a network client 26, and/or other locations through a local-area network (“LAN”) (not shown) or wide-area network (“WAN”) 28. Additionally, components of the video analytics subsystem 12 may be co-located or embedded within other components of the system 10. For example, the video system interface 24 may be implemented on the network client 26 as a web browser or a plug-in to existing data analytic and/or video software application.

The data analytics subsystem 14 includes a point of transaction terminal 30 for collecting information relating to transactions within the monitored facility. The point of transaction terminal 30 may be a point of sale (“POS”) register for collecting information relating to sales transactions conducted upon check-out. The point of transaction terminal 30 may include a communication interface for transmitting data with a data engine 32. The data engine 32 receives data concerning transactions completed, initiated or voided from one or more POS registers 30. The data analytics server 32 analyzes the transaction data to determine if any transactions or group of transactions meet conditions determined according to preset rules as well as post event mining. The data analytics system interface 24 allows a user to set the rules and conditions for the data engine 32 and to generate and view reports.

An integration server 36 combines elements of the video engine 20 and the data engine 32 to correlate transaction events occurring at a point of transaction terminal 30 with the recognition of objects detected by the video engine 20. The integration server 36 may contain the video engine 20 and/or the data engine 32. Additionally, data analytics system interface 24 and the video system interface 24 may be combined into a single user interface (i.e., a dashboard) located at the network client 26. Using the dashboard, a user may combine one or more rules from the video analytics system 12 with one or more rules from the data analytics system 14 to create a set of rules for the integration server 36 to determine precisely when very specific events occur. Additionally, the system 10 may include a dashboard for each user type to allow access to only the views and reports that are of importance to their operational needs.

The integration server 36 may be stand-alone or could reside on any application server. The integration server 36 for real time events could also be located at a central corporate level, either on the same hardware server as the data engine 32, or on a dedicated application server. The business intelligence system 10 should be able to sync time across all components. The business intelligence system 10 may be implemented at local stores/locations, at a central corporate office, or a combination thereof connected through the wide-area network 28. The wide area network 16 may include the Internet, intranet, or other communication network. Although the communication network is pictured in FIG. 1 as being a WAN, the principles of the present invention may also apply to other forms of communication networks, such as personal area networks (“PANs”), local area networks (“LANs”), campus area networks (“CANs”), metropolitan area networks (“MANs”), etc.

While the overall system 10 might be very complex, daily usage is extremely user-friendly and intuitive. The system 10 advantageously provides an easy to use video system interface 24, data analytics system interface 34, and reporting packages to analyze data and view live and stored video that supports alerts and patterns.

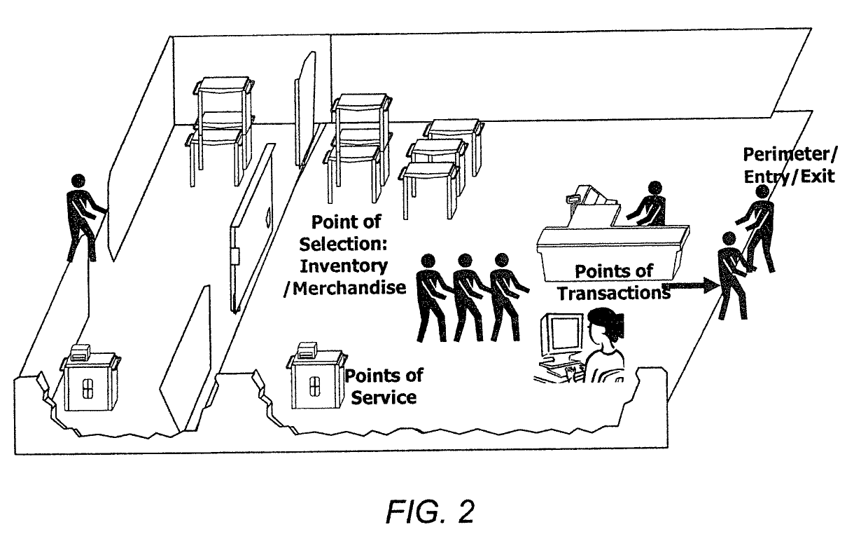

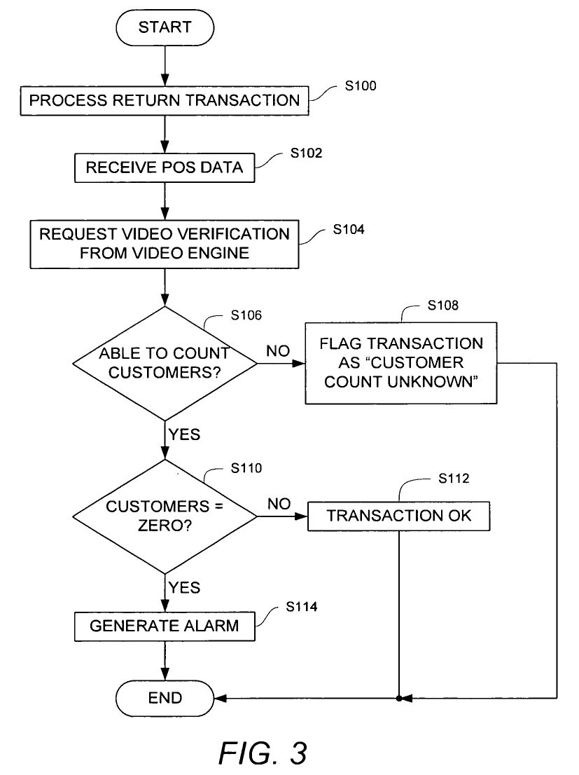

Referring now to FIG. 2, a layout of an exemplary local retail facility 38 is shown which details potential video monitoring locations and data collection sites in accordance with the principles of the present invention. Although FIG. 2 shows a retail facility, the invention is not limited to such. It is contemplated that any monitored facility can be implemented and supported by the present invention, such as a warehouse or other location where merchandise or assets enters or leaves. The system 10 is programmable and is capable of providing business and operational intelligence to operation facility entry/exit points 40, points of sales (i.e., transactions) such as check-out lines 42 or customer service portals 44, service points 46, and points of selection 48 throughout the interior and exterior of the monitored facility. In FIG. 3, an exemplary operational flowchart is provided that describes steps performed in determining that a return transaction has transpired without the presence of an actual customer. In one embodiment, the process allows store managers or Loss Prevention (“LP”) professionals to monitor in real time when returns happen while no customer is present in front of POS counters. At least one video camera 16 should be monitoring the area surrounding a given POS register 30. When a return transaction is processed at the POS register 30 (step S100), the data engine 32 receives the POS data (step S102) regarding the return transaction. The data may include, for example, an identifier for the POS register, the type of transaction, the time of transaction, the name or other identifier of the employee performing the transaction, the amount of the transaction, etc. The data engine 32 requests a visual verification from the video engine 20 (step S104).

The video engine 20 attempts to count the number of customers present in front of the POS register (step S106). If the video engine 20 is unable to count the customers, the transaction is flagged as “customer count unknown” (step S108). For example certain environmental conditions, such as sudden lighting changes, very dim lighting, poor video quality, intense glare in the image, camera motion may prevent the video engine 20 from being able to determine an accurate customer count. All transactions flagged as “customer count unknown” may constitute suspicious activity and details of the transaction may be included in a report for further review at some later time.

If the video engine 20 returns a customer count not equal to zero (step S110), indicating that at least one customer is present at the check out counter, the transaction is deemed to be proper (step S112) and no further action is taken. However, if the video engine 20 returns a customer count equal to zero (step S110), indicating that no customers are present at the check out counter, an alarm of “return fraud” is generated (step S114) and the return transaction is flagged. The alarm may be displayed on the dashboard, saved in a database, sent to the video recorder 18, and/or sent to an event handler in the video analytics system 12. If a user wishes to playback the corresponding video, he/she merely selects an alarm indicator from the dashboard and the video is then replayed and flagged as “viewed.” All flagged transactions are available for post-event mining.

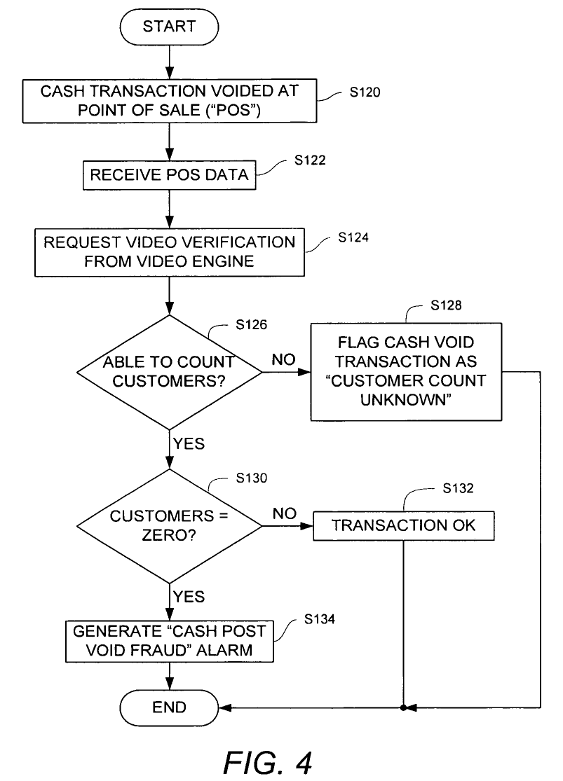

Referring now to FIG. 4, an exemplary operational flowchart is provided that describes steps performed in determining that a cash transaction has been voided without the presence of an actual customer. As in the case described above, at least one video camera 16 should be monitoring the area surrounding a given POS register 30. When a cash transaction is voided at the POS register 30 (step S120), the data engine 32 receives the POS data (step S122) regarding the cash transaction. The data engine 32 requests a visual verification from the video engine 20 (step S124). The video engine 20 attempts to count the number of customers present in front of the POS register (step S126). If the video engine 20 is unable to count the customers, the cash void transaction is flagged as “customer count unknown” (step S128). All transactions flagged as “customer count unknown” may constitute suspicious activity and details of the transaction may be included in a report for further review at some later time.

If the video engine 20 returns a customer count not equal to zero (step S130), indicating that at least one customer is present at the check out counter, the transaction is deemed to be proper (step S132) and no further action is taken. However, if the video engine 20 returns a customer count equal to zero (step S130), indicating that no customers are present at the check out counter, an alarm of “cash post void fraud” is generated (step S134) and the cash void transaction is flagged. As in the case of a return fraud, the alarm may be displayed on the dashboard, saved in a database, sent to the video recorder 18, and/or sent to an event handler in the video analytics system 12. If a user wishes to playback the corresponding video, he/she merely selects an alarm indicator from the dashboard and the video is then replayed and flagged as “viewed.” All flagged transactions are available for post-event mining.

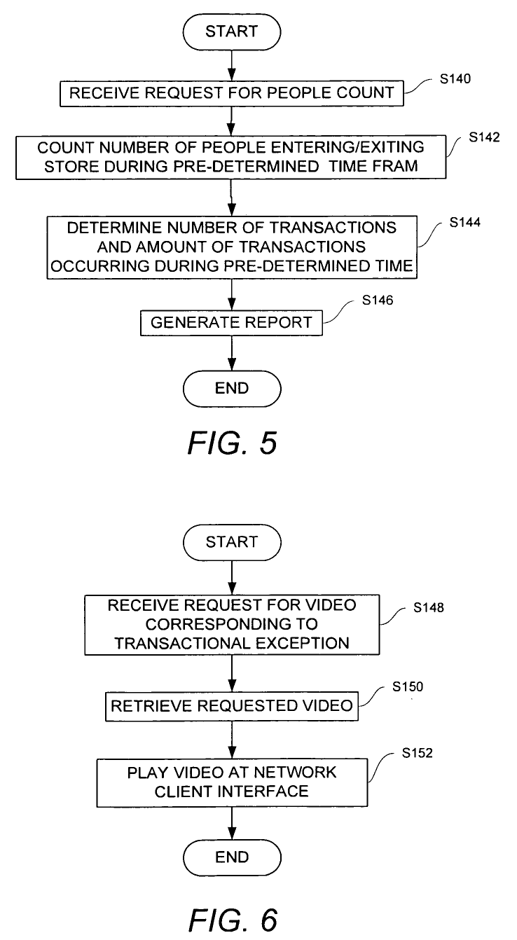

Referring now to FIG. 5, an exemplary operational flowchart is provided that describes steps performed in counting the number of people entering and exiting the store over periods of time and detect periods of high traffic in, or high net occupancy. In one embodiment, this information is combined with data from sales and staffing systems to determine peaks and troughs for store staffing and sales conversion calculations. At least one video camera 16 should be monitoring each entry and/or exit location in the store.

Using the dashboard, a user requests initiates the people counting feature and designated the time frame for the count. The integration server 36 receives the request for people count (step S140) and instructs the video engine 20 to count the number of people photographed entering and/or exiting the store during the pre-determined time frame (step S142). The data engine 20 determines the number of transactions and the total amount of the transactions occurring during the pre-determined time frame (step S144). A report of the results is generated (step S146) and a visual representation of the report is displayed in the dashboard.

Referring now to FIG. 6, an exemplary operational flowchart is provided that describes steps performed in playing back recorded video corresponding to a transactional exception (i.e., events that have been flagged as potentially containing suspicious activity). The integration server 36 receives a request for video corresponding to a transactional exception (step S148). The integration server 36 retrieves the corresponding video from the video recording system 18 (step S150) and plays the requested video (step S152) at the network client interface 26 using, for example, the dashboard.

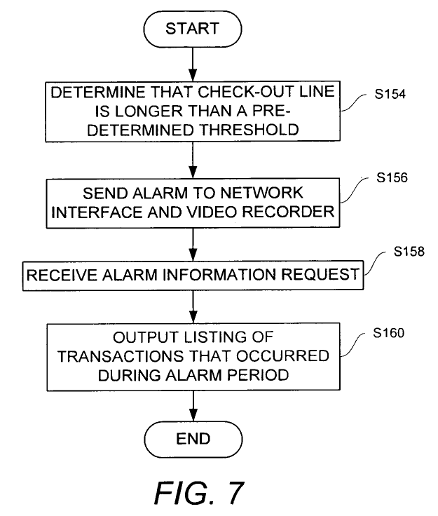

FIG. 7 provides an exemplary operational flowchart that describes steps performed in measuring check-out line durations. In one embodiment, the present invention allows store managers or other corporate operation personnel to identify the instances where the check out waiting line is longer than a pre-defined threshold or the waiting time is longer than a pre-defined threshold, and retrieve corresponding POS data. This feature allows users to investigate the underlying factors causing the delay, such as when someone has a big purchase, an insufficient amount of check-out registers are open, etc.

The video engine 20, using object-recognition algorithms, determines that a check-out line or the duration of time spent in a check-out line is longer than a predetermined threshold (step S154). An alarm is sent to the network client interface 26 and to the video recorder 18 (step S156). The alarm may be displayed, for example, in an event handler of the network client interface 26 or on an alarm list in the video controller 22. The integration server 36 receives an alarm information request requesting transaction data occurring at the time of the alarm (step S158). The alarm information request may be initiated by, for example, a user clicking on an alarm displayed at the network client interface 26. The data engine 32 outputs a listing of transactions that occurred during the alarm period (step S160). The listing may be displayed at the network client interface 26 or may be printed to a physical copy.

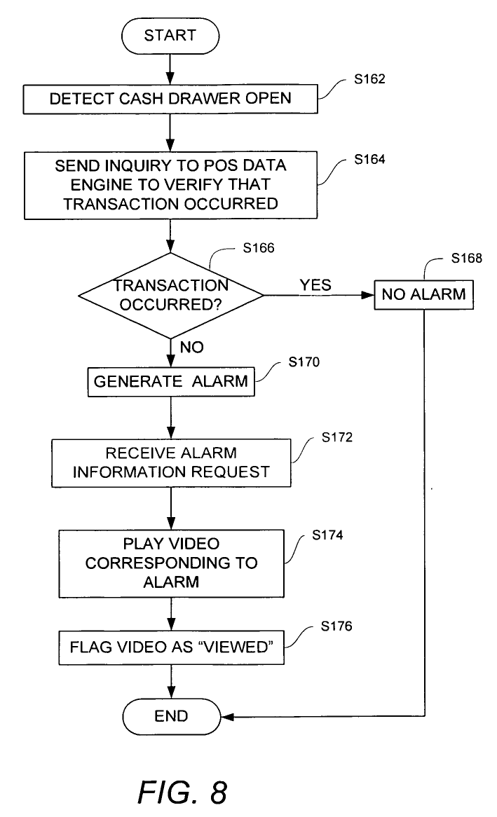

Referring now to FIG. 8, an exemplary operational flowchart is provided that describes steps performed to determine whether a cash register drawer has potentially been improperly opened. The video engine 20 detects the cash drawer open (step S162). The integration server 36 sends an inquiry to the data engine 32 and/or the Point of transaction terminal 30 to verify if any transaction occurred (step S164). If a transaction did occur (step S166), no alarm is required (step S168) and the process ends. However, if no transaction occurred (step S168), then an alarm is generated (step S170) which may be displayed on the dashboard, saved in a database, and/or sent to the video recorder 18 and the network client interface 26. The integration server 36 receives an alarm information request requesting the video recorded during the alarm period (step S172). The alarm information request may be initiated by, for example, a user clicking on an alarm displayed at the network client interface 26. The corresponding video is then played back (step S174), for example, using the dashboard, and the corresponding video is flagged as “viewed” (step S176).

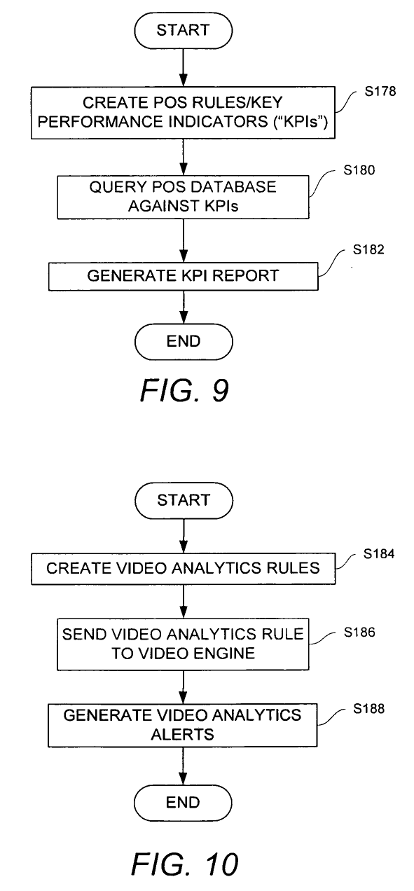

FIG. 9 provides an exemplary operational flowchart that describes steps performed to set up POS rules and generating exception reports. In one embodiment, retail store managers or other corporate operations personnel are able to define POS data rules and Key Performance Indicators (“KPIs”) using the dashboard (step S178). For example, these rules may be as simple as compiling a list of all the returns made in a store or corporation, or just the returns for a specific register and/or specific employee and/or specific product and/or specific times. This provides the ability to perform complex data mining on any type of data being captured by the system. The data engine 32 queries the database of the point of transaction terminal 30 against the rules/KPIs (step S180) and generates a KPI report listing any exception to the rules/KPIs (step S182).

FIG. 10 provides an exemplary operational flowchart that describes steps performed to set up user-definable video rules and generating alarms identifying violations. In a similar manner as that described above in relation to defining POS data rules, as detailed in FIG. 9, an embodiment of the present invention also provides a means for setting up video analytics rules. Retail store managers, loss prevention professional, or other corporate operations personnel are able to define video analytics rules using the dashboard (step S184). The video analytics rules may include rules for alerting when any specific visual patterns, behaviors, or content are detected. The video analytics rules are sent to the video engine 20 and any embedded edge devices (step S186). Video analytics alerts are generated whenever the video engine 20 determines that at least one video analytics rule has been violated (step S188).

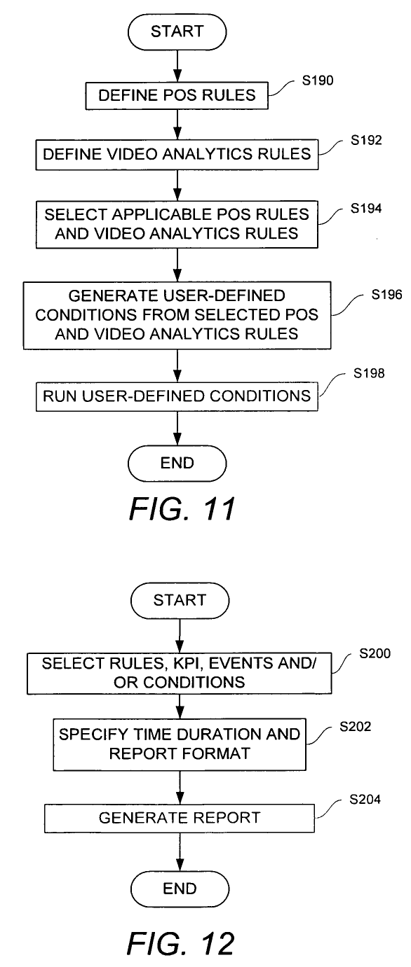

FIG. 11 provides an exemplary operational flowchart that describes steps performed to combine POS data rules and video analytics rules to precisely define specific alarm events. In this manner, data intelligence and video intelligence are integrated to determine when specific events occur as defined according to the needs of the user. POS data rules are defined using a user interface such as the dashboard (step S190). Video analytics rules are also defined using the dashboard (step S192). Applicable POS rules and video analytics rules are selected (step S194) and combined using logical operations, e.g., AND, OR, NOT, IF FALSE, TRUE, etc., to generate user-defined conditions (step S196). The user-defined conditions are then run to generate real time events or to conduct after-the-fact searches (step S198).

Referring now to FIG. 12, an exemplary operational flowchart is provided that describes steps performed to generate reports against all rules/KPIs, alarms and events. Desired rules, KPIs, events, and/or conditions are selected (step S200) and the time duration and report format are specified (step 202). The integration server 36 selects POS data and video recordings corresponding to the selected rules, KPIs, events and or conditions occurring within the specified time duration to generate a report in the specified format (step S204). The reports may be used to further investigate and identify suspicious activity and/or improve overall store management capabilities.

From a security standpoint, the software solution may support automatically authenticated connections such as Integrated Windows Authentication (“IWA”), also known as NT authentication. Security features may limit local application-specific user IDs. Passwords should be used to access the system 10. Although permissions based on LAN ID may be used, additional security features may also be used. Membership in one or more active directory groups may be used. With active directory support, users are not required to provide any additional authentication when launching the application. Security should be based on the identity of the currently logged-on workstation user, with verification of privileges taking place automatically behind the scenes. The application itself may have strong database security standards, with multiple layers of security applied to the database system as a whole, as well as individual tables within the database.

The software provides automatic operation log and remote bugs/defects/issues reporting to central server. Bugs are automatically collected by the software. End-users can submit their own bugs via web site or through the application itself. All databases and records are able to be backed up and archived. The installation processes for any applications in the system of the invention may be silent, automated installation on both server and workstation. The software deployments can follow standard scripting tools (SMS, for example) and require no user interaction. Remote configuration can also be available. Updates can also be conducted remotely. The configuration processes are user-friendly, including but not limited to automatically detecting video recording devices within a LAN, and providing a graphical user interface for any configuration of all devices and components. The integration server 36 may be compatible with commonly used enterprise server environments, including but not limited to enterprise web servers, enterprise application servers, and enterprise database servers.

Other features that may be embodied into the system of the invention include a store gateway for collecting video analytics alerts and counting data, transporting the data to corporate for transfer to a database in database and leveraging a file transfer protocol (“FTP”) server approach, presenting video analytics alerts and acknowledgement at the store level, configuration of video alerts through a rule management tool or an integrated interface, and presenting Exception reporting/data mining/trends analysis of POS data with video analytics and video verification.

The system 10 may also include artificial intelligence to distinguish alerts versus exception reporting paths. Examples illustrating the differences for video analytics include but are not limited to traveling into unauthorized areas for deliveries, restricted stock areas, hiding merchandise, dwelling or loitering for too long a period of time indicating potential suspicious behavior or a need for assistance, and groups of people congregating indicating potential suspicious activity. Examples illustrating the differences for exception reporting/trend analysis with data and video analytics with POS focus include but are not limited to invalid transactions due to absence of customers, invalid transactions due to absence of manager, line queuing, and people counting.

The system 10 may be programmable to allow for the definition and configuration of corporate wide video analytics during initial installation at the store level. The system 10 may also incorporate a store level solution programmable for handle addressing, database modification, transport, and other store level video management functions. Data input may be taken from video surveillance and video analytics, and integrated with mapping information, such as mapping between cameras and register/aisles.

Aspects of the database for the system may include using data feeds from video surveillance and video analytics, and the mapping data. Some possible data fields contemplated include but are not limited to Count, Date/Time, RuleID, CameraID, and Rule Type (occupancy, etc). Data mapping may include: StoreID, OrganizationID, Reference#, ReferenceType (register, aisle, etc.), and ActivityType (customer occupancy, item scan, etc.).

A time synchronization mechanism may be used to link POS data with video information, perhaps similar to how registers sync POS data time. The system 10 may be structured to allow video analytics rules to be managed (change control) at an enterprise-wide level, and not just at a store or location level. Rules management approaches may be include that will facilitate initial configurations and future updates. One approach is to set up zones at the store level and apply rules at the corporate/enterprise level. In the area of transport, data may be located in a flat file or structured database located in a folder at store level and collected and transported via a network to another location with other data like POS. The data can then be made available for a database transfer. An alternative approach is to use an FTP-based transfer mechanism.

The invention advantageously provides a high degree of sensitivity/detectablity with regard to revealing problem areas. The user is able to address issues with employees and customers sooner through disciplinary action, improvements in customer service, or even training improvements. By combining sources of data and analysis in the automatable system of the invention, the output will be more reliable and accurate and minimize or eliminate false alarms. False alarms can undermine confidence in the solution and limit its success.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for detecting potential suspicious behavior in a monitored facility, the method comprising:
collecting video content of an activity occurring at the monitored facility;
collecting transaction data relating to a transaction processed at a point of transaction terminal;
correlating the video content with the transaction data to produce correlated data; and
applying a set of user-defined rules to the correlated data; and
responsive to identifying a match between the correlated data and at least one rule of the set of user-defined rules, determining that the transaction is potentially suspicious.

2. The method of claim 1, wherein the set of user-defined rules includes a combination of one or more video analytics rules and one or more data analytics rules.

3. The method of claim 2, further comprising:
marking the video content with a first timestamp indicating a time the activity occurred; and
marking the transaction data with a second timestamp indicating a time the transaction was processed,
wherein the video content is correlated with the transaction data by matching the first timestamp with the second timestamp.

4. The method of claim 3, wherein:
the data analytics rules include rules to determine that a return transaction has occurred; and
the video analytics rules include rules to determine that no customers are at the point of sale register.

5. The method of claim 3, wherein:
the data analytics rules include rules to determine that a cash transaction has been voided; and
the video analytics rules include rules to determine that no customers are at the point of sale register.

6. The method of claim 3, wherein:
the data analytics rules include rules to determine that no transaction has occurred; and
the video analytics rules include rules to determine that a drawer of the point of sale register is open.

7. A method of automatically identifying activities occurring at a monitored facility, the method comprising:
collecting video content of activity occurring at the monitored facility;
analyzing the video content using object recognition techniques by applying a set of video analytics rules to the collected video content;
collecting transaction data relating to one or more transactions processed by at least one point of transaction terminal within the sales facility; and
responsive to determining that the video content conforms to at least one video analytics rule of the set of video analytics rules, correlating the video content with the transaction data to provide correlated transaction data.

8. The method of claim 7, further comprising:
marking the video content with a first timestamp indicating a time the activity occurred; and
marking the transaction data with a second timestamp indicating a time the transaction was processed,
wherein the video content is correlated to the transaction data by matching the first timestamp with the second timestamp.

9. The method of claim 8, further comprising responsive to determining that the video content conforms to at least one video analytics rule of the set of video analytics rules, generating an alarm.

10. The method of claim 9, further comprising using the transaction data to determine why the video content conforms to at least one video analytics rule of the set of video analytics rules.

11. The method of claim 9, wherein the at least one video analytics rule includes a rule to determine that an amount of customers standing in a check-out line exceeds a predetermined threshold.

12. The method of claim 9, wherein the at least one video analytics rule includes a rule to determine that a duration of time that a customer has spent standing in a check-out line exceeds a predetermined threshold.

13. The method of claim 8, further comprising:
responsive to determining that the video content conforms to at least one video analytics rule of the set of video analytics rules, generating a report detailing transactions occurring while the video content conforms to at least one video analytics rule.

14. The method of claim 13, wherein the at least one video analytics rule includes a rule to determine an amount of customers entering and exiting the sales facility.

15. A system for analyzing activities occurring at a monitored facility, the monitored facility including at least one point of transaction terminal, the system comprising:
a video analytics system, the video analytics system operable to collect video content of activities occurring at the monitored facility;
a data analytics system, the data analytics system operable to collect transaction data relating to one or more transactions processed by the at least one point of transaction terminal; and
an integration server communicatively coupled to the video analytics system and the data analytics system, the integration server operable to:
correlate the video content to the transaction data to produce correlated data;
apply a set of user-defined rules to the correlated data; and
identify a match between the correlated data and at least one rule of the set of user-defined rules.

16. The system of claim 15, wherein the integration server is further operable to determine that the one or more transactions are potentially suspicious and generate an alarm, the system further comprising a client interface communicatively coupled to the integration server, the client interface operable to indicate the alarm.

17. The system of claim 16, wherein the client interface is further operable to receive the set of user-defined rules, the set of user-defined rules including a combination of one or more video analytics rules and one or more data analytics rules.

18. The system of claim 17, wherein the video content includes a first timestamp indicating the time the activity occurred and the transaction data includes a second timestamp indicating the time the transaction was processed, the integration server is further operable to correlate the video content to the transaction data by matching the first timestamp with the second timestamp.

19. The system of claim 18, wherein:
the data analytics rules include rules to determine that a return transaction has occurred; and
the video analytics rules include rules to determine that no customers are at the point of transaction terminal.

20. The system of claim 18, wherein:
the data analytics rules include rules to determine that a cash transaction has been voided; and
the video analytics rules include rules to determine that no customers are at the point of transaction terminal.
